(19) United States
(12) Patent Application Publication
(10) Pub. No.: US 2021/0319011 A1
(43) Pub. Date: Oct. 14, 2021

(54) METADATA TABLE RESIZING MECHANISM FOR INCREASING SYSTEM PERFORMANCE

(71) Applicant: SAMSUNG ELECTRONICS CO., LTD., Suwon-si (KR)

(72) Inventors: Heekwon Park, Cupertino, CA (US); Yang Seok Ki, Palo Alto, CA (US); llgu Hong, Santa Clara, CA (US); Ho bin Lee, San Jose, CA (US)

(21) Appl. No.: 16/878,551

(22) Filed: May 19, 2020

Related U.S. Application Data
(60) Provisional application No. 63/007,287, filed on Apr. 8, 2020.

(51) Int. Cl. G06F 16/23

(52) U.S. Cl. CPC G06F 16/2379

(57) ABSTRACT

Provided is a method of database management, the method including identifying an attribute of a metadata table causing increased input/output overhead associated with accessing the metadata table, and dividing the metadata table into one or more submetadata tables to reduce or eliminate the attribute, or to isolate the attribute to one of the submetadata tables.

### CROSS-REFERENCE TO RELATED APPLICATION(S)

This application claims priority to and the benefit of U.S. Provisional Application Ser. No. 63/007,287, filed on Apr. 8, 2020, the entire content of which is incorporated herein by reference.

### FIELD

One or more aspects of embodiments of the present disclosure relate generally to methods of updating a metadata table in a database to increase system performance.

### BACKGROUND

A key-value solid state drive (KVSSD) may provide a key-value interface at the device level, thereby providing improved performance and simplified storage management. This can, in turn, enable high-performance scaling, simplification of a conversion process (e.g., data conversion between object data and block data), and extension of drive capabilities. By incorporating a KV store logic within a firmware of the KVSSD, KVSSDs may be able to respond to direct data requests from a host application while reducing involvement of host software. The KVSSD may use standard SSD hardware that is augmented by using Flash Translation Layer (FTL) software for providing processing capabilities.

The above information disclosed in this Background section is only for enhancement of understanding of the background of the disclosure, and therefore may contain information that does not form the prior art.

### SUMMARY

Embodiments described herein provide improvements to data storage and to database management.

According to some embodiments, there is provided a method of database management, the method including identifying an attribute of a metadata table causing increased input/output overhead associated with accessing the metadata table, and dividing the metadata table into one or more submetadata tables to reduce or eliminate the attribute, or to isolate the attribute to one of the submetadata tables.

Identifying the attribute causing increased input/output overhead may include identifying a hot key in the metadata table, wherein the one of the submetadata tables contains the hot key.

The method may further include receiving a key update corresponding to the hot key, and performing a read-modify-write operation on the one of the submetadata tables.

Identifying the attribute causing increased input/output overhead may include identifying a key prefix corresponding to a key-value pair of the metadata table that is assigned based on an attribute of the key-value pair, wherein the one of the submetadata tables contains keys corresponding to the key prefix.

The method may further include receiving a key update corresponding to a hot key associated with the key prefix, and performing a read-modify-write operation on the one of the submetadata tables.

Identifying the attribute causing increased input/output overhead may include monitoring a ratio of write latency to metadata table size for one or more metadata tables including the metadata table, respectively, and detecting the ratio for the metadata table as being beyond a threshold ratio.

An overall write latency associated with the one or more submetadata tables may be less than an overall write latency associated the metadata table.

According to other embodiments, there is provided a key value store for storing data to a storage device, the key value store being configured to identify an attribute of a metadata table causing increased input/output overhead associated with accessing the metadata table, and divide the metadata table into one or more submetadata tables to reduce or eliminate the attribute, or to isolate the attribute to one of the submetadata tables.

The key value store may be configured to identify the attribute causing increased input/output overhead by identifying a hot key in the metadata table, wherein the one of the submetadata tables contains the hot key.

The key value store may be further configured to receive a key update corresponding to the hot key, and perform a read-modify-write operation on the one of the submetadata tables.

The key value store may be configured to identify the attribute causing increased input/output overhead by identifying a key prefix corresponding to a key-value pair of the metadata table that is assigned based on an attribute of the key-value pair, wherein the one of the submetadata tables contains keys corresponding to the key prefix.

The key value store may be further configured to receive a key update corresponding to a hot key associated with the key prefix, and perform a read-modify-write operation on the one of the submetadata tables.

The key value store may be configured to identify the attribute causing increased input/output overhead by monitoring a ratio of write latency to metadata table size for one or more metadata tables including the metadata table, respectively, and detecting the ratio for the metadata table as being beyond a threshold ratio.

An overall write latency associated with the one or more submetadata tables may be less than an overall write latency associated the metadata table.

According to yet other embodiments, there is provided a non-transitory computer readable medium implemented with a key value store for storing data to a storage device, the non-transitory computer readable medium having computer code that, when executed on a processor, implements a method of database management, the method including identifying an attribute of a metadata table causing increased input/output overhead associated with accessing the metadata table, and dividing the metadata table into one or more submetadata tables to reduce or eliminate the attribute, or to isolate the attribute to one of the submetadata tables.

Identifying the attribute causing increased input/output overhead may include identifying a hot key in the metadata table, wherein the one of the submetadata tables contains the hot key.

The computer code, when executed on a processor, may further implement the method of database management by receiving a key update corresponding to the hot key, and performing a read-modify-write operation on the one of the submetadata tables.

Identifying the attribute causing increased input/output overhead may include identifying a key prefix corresponding to a key-value pair of the metadata table that is assigned based on an attribute of the key-value pair, wherein the one of the submetadata tables contains keys corresponding to the key prefix.

The computer code, when executed on a processor, may further implement the method of database management by receiving a key update corresponding to a hot key associated with the key prefix, and performing a read-modify-write operation on the one of the submetadata tables.

Identifying the attribute causing increased input/output overhead may include monitoring a ratio of write latency to metadata table size for one or more metadata tables including the metadata table, respectively, and detecting the ratio for the metadata table as being beyond a threshold ratio.

Accordingly, embodiments of the present disclosure improve data storage technology by providing methods for resizing a metadata table in a database, the provided methods enabling reduction of read-modify-write (RMW) overhead, reduction of write latency, reduction of write amplification factor (WAF), reduction of metadata table build time, and improvement of spatial locality.

### BRIEF DESCRIPTION OF THE DRAWINGS

Non-limiting and non-exhaustive embodiments of the present embodiments are described with reference to the following figures, wherein like reference numerals refer to like parts throughout the various views unless otherwise specified.

FIG. 1 is a block diagram depicting a first method of resizing a metadata table according to some embodiments of the present disclosure;

FIG. 2 is a block diagram depicting a second method of resizing a metadata table according to some embodiments of the present disclosure;

FIG. 3 is a block diagram depicting a third method of resizing a metadata table according to some embodiments of the present disclosure;

FIG. 4 is a flowchart depicting a method of crash recovery according to some embodiments of the present disclosure; and

FIG. 5 is a flowchart depicting a method of database management according to some embodiments of the present disclosure.

Corresponding reference characters indicate corresponding components throughout the several views of the drawings. Skilled artisans will appreciate that elements in the figures are illustrated for simplicity and clarity, and have not necessarily been drawn to scale. For example, the dimensions of some of the elements, layers, and regions in the figures may be exaggerated relative to other elements, layers, and regions to help to improve clarity and understanding of various embodiments. Also, common but well-understood elements and parts not related to the description of the embodiments might not be shown in order to facilitate a less obstructed view of these various embodiments and to make the description clear.

### DETAILED DESCRIPTION

Features of the inventive concept and methods of accomplishing the same may be understood more readily by reference to the detailed description of embodiments and the accompanying drawings. Hereinafter, embodiments will be described in more detail with reference to the accompanying drawings. The described embodiments, however, may be embodied in various different forms, and should not be construed as being limited to only the illustrated embodiments herein. Rather, these embodiments are provided as examples so that this disclosure will be thorough and complete, and will fully convey the aspects and features of the present inventive concept to those skilled in the art. Accordingly, processes, elements, and techniques that are not necessary to those having ordinary skill in the art for a complete understanding of the aspects and features of the present inventive concept may not be described.

In the detailed description, for the purposes of explanation, numerous specific details are set forth to provide a thorough understanding of various embodiments. It is apparent, however, that various embodiments may be practiced without these specific details or with one or more equivalent arrangements. In other instances, well-known structures and devices are shown in block diagram form in order to avoid unnecessarily obscuring various embodiments.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, the term “substantially,” “about,” “approximately,” and similar terms are used as terms of approximation and not as terms of degree, and are intended to account for the inherent deviations in measured or calculated values that would be recognized by those of ordinary skill in the art. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.”

When a certain embodiment may be implemented differently, a specific process order may be performed differently from the described order. For example, two consecutively described processes may be performed substantially at the same time or performed in an order opposite to the described order.

The electronic or electric devices and/or any other relevant devices or components according to embodiments of the present disclosure described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate.

Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the embodiments of the present disclosure.

Unless otherwise defined, all terms (including technical and scientific terms) used herein have the same meaning as commonly understood by one of ordinary skill in the art to which the present inventive concept belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

One or more metadata tables may be used to maintain information regarding keys associated with key-value (KV) pairs in a database. For example, when a KV pair saved to a storage device, metadata that is associated with a new record corresponding to the storage of the KV pair may also be saved. Some types of metadata may correspond to the expiration of the stored KV pair, which may also be referred to as “Time to Live” (TTL), to a “compare and swap” (CAS) value, which may be provided by a client to demonstrate permission to update or modify the corresponding object or value, to one or more flags, which may be used to either identify the type of data stored or specify formatting (e.g., to signify a data type of an object or value that is being stored), or to a sequence number, which may be used for conflict resolution of keys that are updated concurrently on different clusters, the sequence number keeping track of how many times the value of the KV pair is modified. However, it should be noted that other types of metadata may be stored in the one or more metadata tables of the disclosed embodiments.

A key update process for updating a key generally causes a Read-Modify-Write (RMW) operation of the metadata table. That is, a key update generally results in 1) a reading of the metadata table to which the key belongs, 2) modification of the metadata table, and 3) writing back data to the metadata table (e.g., such that an updated metadata table is saved to a storage device, such as a KV storage device or KV solid state drive (KVSSD)).

During an RMW operation, an entirety of the metadata table may be written back to the KV device even if only a single key of the metadata table is updated via the key update process. Accordingly, if the metadata table is relatively large, and if only a few of the keys corresponding to the metadata table are updated relatively frequently (e.g., if only a few of the keys are “hot” keys), then various types of overhead that negatively affect system performance may result. For example, frequent writing back of a relatively large metadata table to the KV device may result in long write latency, may increase a write amplification factor (WAF), may increase a metadata table build time, etc.

Accordingly, some embodiments of the present disclosure provide improvements for data storage by providing methods for resizing one or more metadata tables to increase system performance.

For example, according to some embodiments, a metadata table may be resized according to three different conditions, aspects, or attributes, that are related to the metadata table (e.g., aspects or attributes that are related to the data that is stored in the metadata table). These conditions/aspects/attributes correspond to the frequency of key access (e.g., storing frequently updated “hot” keys and infrequently updated “cold” keys in separate respective metadata tables), grouping of frequently accessed keys, grouping keys by different attributes that have different prefixes, and write latency as a function of metadata table size. Methods for resizing the metadata table, which respectively correspond to these conditions, are discussed in turn below.

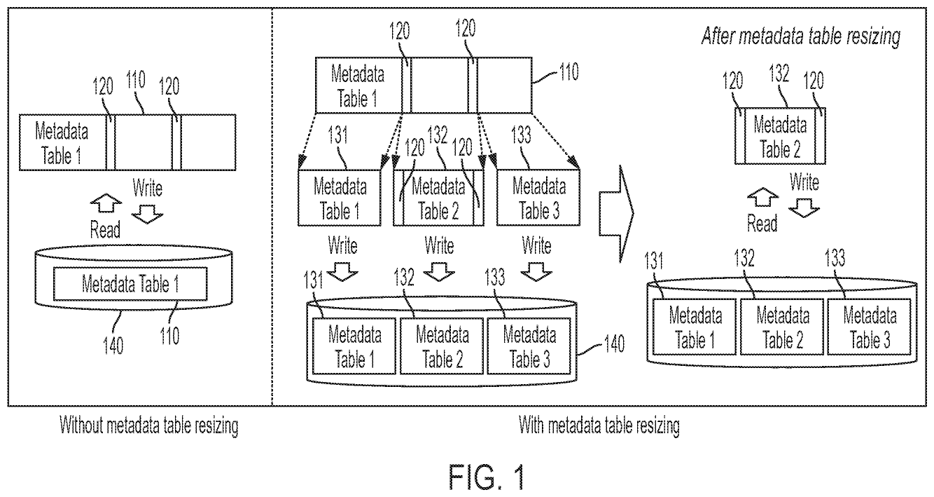

FIG. 1 is a block diagram depicting a first method of resizing a metadata table according to some embodiments of the present disclosure.

Referring to FIG. 1, as mentioned above, when any key 120 is updated, thereby causing an RMW process, an entire metadata table 110 may be written back to a storage device 140 (e.g., a KV device, such as a KVSSD).

According to some embodiments, however, an initial metadata table 110 may be resized to be one or more smaller metadata tables, or submetadata tables (e.g., first, second, and third submetadata tables 131, 132, and 133). For example, as shown in FIG. 1, the initial metadata table 110 may be resized based on locations of one or more frequently overwritten user keys (e.g., hot keys 120) within the initial metadata table 110, thereby enabling the isolation of the hot keys 120. That is, to reduce RMW overhead by removing the associated overheads discussed above, a relatively large initial metadata table 110 may be split or divided into two or more smaller metadata tables. In the present example, the smaller metadata tables are referred to as first, second, and third submetadata tables 131, 132, and 133. The resizing or splitting of the initial metadata table 110 may occur during a write operation in which the metadata table 110 is written to the storage device 140, or during a flushing operation of the metadata table 110 during which the metadata table 110 is deleted from memory and stored in the storage device 140.

In the present example, as shown in FIG. 1, it may be determined that two non-consecutive hot keys 120 are contained in the initial metadata table 110. Then, the initial metadata table 110 may be divided into multiple submetadata tables 131, 132, 133 based on the location of the hot keys 120. For example, the initial metadata table 110 may be divided such that the hot keys 120 include the first and last key of a second submetadata table 132 corresponding to a middle portion of the initial metadata table 110. Accordingly, the remaining first and third submetadata tables 131 and 133 are entirely separate of the identified hot keys 120, and may include only cold keys. Therefore, the second submetadata table 132 may be rewritten to the storage device 140 during a RMW operation corresponding to a key update of a key of the second submetadata table 132 without having to rewrite any portion of the first and third submetadata tables 131 and 133.

Accordingly, the initial metadata table 110 may be resized with the intention of isolating hot keys 120 into one or more submetadata tables 131, 132, 133, such that submetadata tables not containing the hot keys 120 (e.g., submetadata tables 131 and 133) may be updated less frequently. That is, a metadata table may have a data capacity of a given size (e.g., size on disk), or may correspond to a given key range, wherein system performance associated with access of the metadata table may be affected depending on the size of the metadata table. Accordingly, by resizing the initial metadata table 110 (e.g., by dividing the initial metadata table 110 into one or more smaller metadata tables referred to as submetadata tables 131, 132, 133 herein), portions of the initial metadata table 110 corresponding to the first and third submetadata tables 131 and 133 need not be rewritten to the storage device 140 when one or more of the hot keys 120 of the second submetadata table 132 are updated. The described method of splitting the initial metadata table 110 may therefore increase spatial locality corresponding to the storage of the data contained in the submetadata tables 131, 132, 133 on the storage device, and may therefore improve system performance.

It may be noted that, in some embodiments, the first and third submetadata tables 131 and 133 containing cold keys may have a minimum metadata table size. The minimum metadata table size according to some embodiments is not particularly limited. Further, in some embodiments, the second submetadata table 132 containing the one or more hot keys 120 may contrastingly lack any minimum metadata table size requirement (e.g., may not require that the second submetadata table 132 be at least of a certain size on disk). Also, the first and third submetadata tables 131 and 133 may include only cold keys, while the second submetadata table 132 may include only hot keys or may include a combination of hot keys and cold keys.

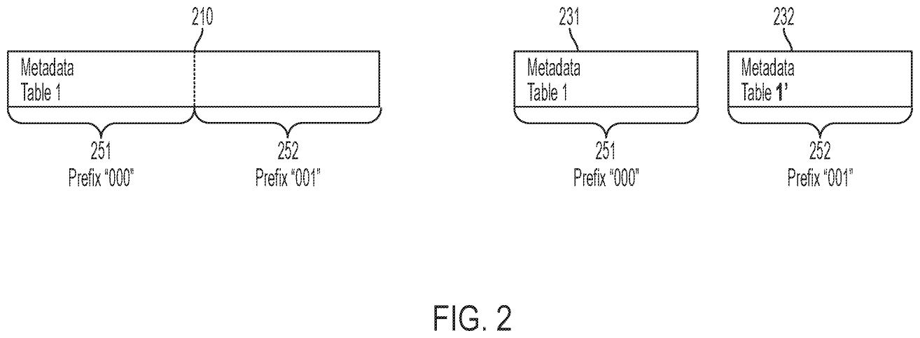

FIG. 2 is a block diagram depicting a second method of resizing a metadata table according to some embodiments of the present disclosure.

Referring to FIG. 2, databases may use different key prefixes for key-values having different attributes. Accordingly, the prefixes may be used to classify data in the database (e.g., the data may be classified based on frequency of access, or how frequently the data is updated). Additionally, iterators may be created within a key range of keys corresponding to the same attribute. Such iterators may be created within a common category.

Accordingly, the presence of mixed KV pairs respectively corresponding to different attributes within a single initial metadata table 210 may result in unnecessary I/O overhead. However, such overhead may be eliminated by using different metadata tables, or submetadata tables 131 and 132, for KV pairs with different attributes, as shown in FIG. 2.

For example, as a second method of resizing a metadata table 210, the initial metadata table 210 may be resized based on respective prefixes 251 and 252 of user keys stored in the initial metadata table 210 (e.g., prefixes “000” and “001” in the present example). The initial metadata table 210 may be split into two different submetadata tables 231 and 232, which may be allocated based on different user keys with different respective prefixes 251 and 252, thereby increasing spatial locality. That is, a larger initial metadata table 210 including keys respectively corresponding to one of two different prefixes 251 and 252 may be split into two smaller submetadata tables 231 and 232.

Each submetadata table 231 and 232 may include only keys that are identified by a respective one of the prefixes 251 and 252 (e.g., the first submetadata table 231 may include only keys corresponding to a first prefix 251 while the second submetadata table 232 may include only keys corresponding to a second prefix 252).

In the present example, the second prefix 252 may be appended to the initial metadata table 210 in only a main memory while not being written to a corresponding storage device (e.g., the storage device 140 of FIG. 1). The initial metadata table 210 may be split into the first and second metadata tables 231 and 232 during an RMW operation in which the metadata table 210 would be written to the storage device.

Accordingly, because the frequency with which keys are accesses may correspond to their respective prefix, resizing the initial metadata table 210 into two submetadata tables 231 and 232 may improve spatial locality while reducing overhead associated with RMW operations.

Accordingly, because the iterator may correspond to a respective prefix, resizing the initial metadata table 210 into two submetadata tables 231 and 232 may improve spatial locality while reducing overhead associated with read operations. Further, splitting the initial metadata table 210 based on corresponding prefixes may reduce overhead associated with read operations. For example, if a metadata table that is read by an iterator contains keys that do not belong to the iterator, there may be extra, unneeded overhead. Accordingly, the mechanism of the present example may create a metadata table having only keys belonging to one Iterator. That is, for example, an iterator may read a metadata table that has only the keys belonging to the iterator.

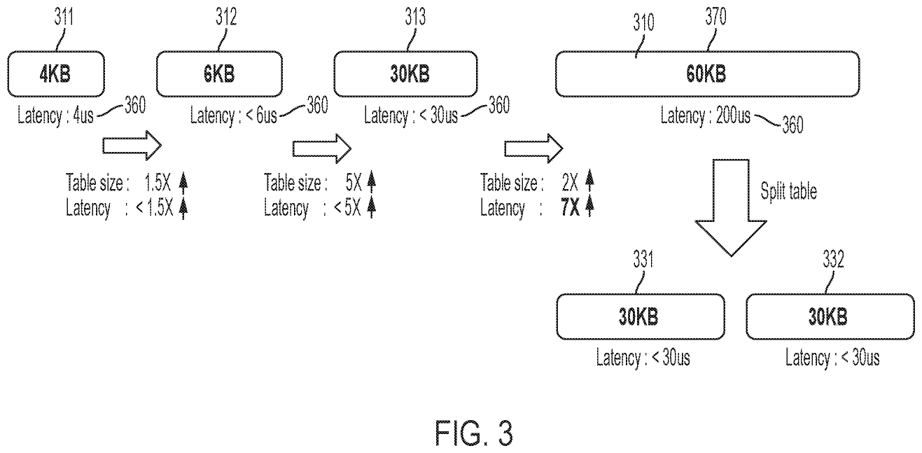

FIG. 3 is a block diagram depicting a third method of resizing a metadata table according to some embodiments of the present disclosure.

Referring to FIG. 3, an initial metadata table 310 may be resized based on a corresponding write latency 360 thereof. For example, if a write latency is disproportionately higher for metadata tables having a size that exceeds a given metadata table size, then a corresponding initial metadata table 310 may be split into two or more smaller submetadata tables 331 and 332 to reduce overall write latency.

That is, KV devices (e.g., the storage device 140 of FIG. 1) may generally have a sudden or disproportionate increase in associated write latency when a metadata table stored, which is stored on the KV device, reaches a threshold of a certain size value. According to some embodiments, a size threshold corresponding to the metadata table size may be determined by monitoring respective ratios of metadata table sizes to write latencies. That is, the metadata table size 370 of various metadata tables (e.g., metadata tables 310, 311, 312, and 313) may be compared to the respective write latencies 360 associated with the metadata tables. When the write latency 360 of an initial metadata table 310 is disproportionately higher than a write latency 360 of a next largest metadata table 313, a decision may be made to split the initial metadata table 310 into two or more smaller submetadata tables 331 and 332. Accordingly, a determination to resize a metadata table 310 may be based on an awareness of a corresponding write latency 360.

In the present example, the size of a metadata table may be increased by beginning with a minimum table size (e.g., metadata table 311 having a size of 4 KB). The metadata tables 311, 312, and 313 included in the database may be variously sized (e.g., 4 KB, 6 KB, 30 KB, etc.). However, if write latency suddenly or disproportionally increases when the size of the metadata table is increased beyond a size threshold (e.g., when the size of the metadata table is increased from 30 KB to 60 KB, in the present example), then metadata tables that have a metadata table size that is greater than the threshold may be resized or split. The threshold may correspond to a point where the disproportionate increase in write latency occurs.

In the present example, upon increasing the size of the metadata table beyond an example threshold (e.g., from a metadata table 313 of a 30 KB size to the initial metadata table 310 of a 60 KB size), associated write latency increases to a degree that far exceeds the degree to which the size of the metadata table has increased (e.g., in the present example, write latency increases by a factor of 7 while the size of the metadata table has only increased by a factor of 2). Accordingly, the initial metadata table 310 may be resized to two or more submetadata tables 331 and 332 having a lower latency-to-table-size ratio.

Accordingly, by detecting a sudden, disproportionate increase in write latency 360, the corresponding initial metadata table 310 may be split to create two smaller submetadata tables 331 and 332, thereby increasing overall write latency.

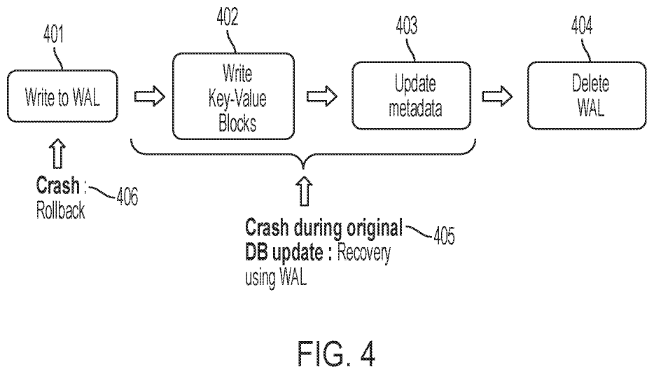

FIG. 4 is a flowchart depicting a method of crash recovery according to some embodiments of the present disclosure.

Referring to FIG. 4, some embodiments of the present disclosure may provide a data recovery mechanism by using a write-ahead log (WAL). When an initial metadata table (e.g., initial metadata tables 110, 210, or 310, as shown in FIGS. 1, 2, and 3) is split into multiple submetadata tables (e.g., submetadata tables 131, 132, and 133, 231 and 232, or 331 and 332, as shown in FIGS. 1, 2, and 3), modifications to the database state may occur. The modifications to the database state may be as follows.

At 401, the system may record the changes to the submetadata tables, which may have been a result of splitting the initial metadata table, to the WAL. At 402, the system may write the KV blocks. The KV blocks may be written to a storage device, such as a KV device (e.g., the storage device 140 of FIG. 1), and may be written corresponding to the changes to the metadata table(s)/submetadata table(s). At 403, the system may update the metadata corresponding to the changes to the metadata table(s)/submetadata table(s). The metadata table may be updated in the storage device. At 404, the system may delete the WAL.

Accordingly, at 405, when a crash occurs during updating of the database (e.g., if a crash occurs at 402 or at 403), the data may be recovered by referring to the WAL at 406.

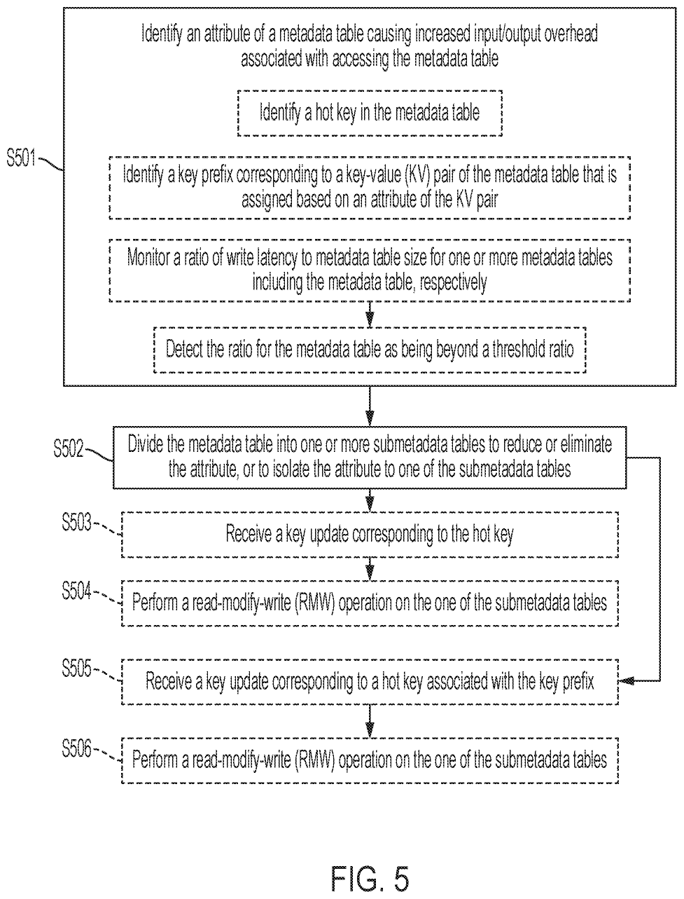

FIG. 5 is a flowchart depicting a method of database management according to some embodiments of the present disclosure.

Referring to FIG. 5, at S501 a metadata table resizing mechanism according to some embodiments may identify an attribute of a metadata table causing increased input/output overhead associated with accessing the metadata table. The attribute of the metadata table may be identified by identifying a hot key in the metadata table, by identifying a key prefix corresponding to a key-value (KV) pair of the metadata table that is assigned based on an attribute of the KV pair, or by monitoring a ratio of write latency to metadata table size for one or more metadata tables including the metadata table, respectively, and detecting the ratio for the metadata table as being beyond a threshold ratio. The first submetadata table may contain the hot key. The first submetadata table may contain all keys corresponding to the key prefix. An overall write latency associated with the one or more submetadata tables may be less than an overall write latency associated the metadata table.

At S502, the mechanism may divide the metadata table into one or more submetadata tables to reduce or eliminate the attribute, or to isolate the attribute to one of the submetadata tables.

At S503, the mechanism may receive a key update corresponding to the hot key. At S504, the mechanism may perform a read-modify-write (RMW) operation on the one of the submetadata tables.

At S505, the mechanism may receive a key update corresponding to a hot key associated with the key prefix. At S506, the mechanism may perform a read-modify-write (RMW) operation on the one of the submetadata tables.

Accordingly, embodiments of the present disclosure provide an improved method and system for data storage by providing methods for determining when and how a metadata table should be split into smaller submetadata tables, the provided methods enabling reduction of RMW overhead by isolating hot keys, reduction of write latency, reduction of WAF, reduction of metadata table build time, and improvement of spatial locality.

While embodiments of the present disclosure have been particularly shown and described with reference to the accompanying drawings, the specific terms used herein are only for the purpose of describing some of the embodiments and are not intended to define the meanings thereof or be limiting of the scope of the claimed embodiments set forth in the claims. Therefore, those skilled in the art will understand that various modifications and other equivalent embodiments of the present disclosure are possible. Consequently, the true technical protective scope of the present disclosure must be determined based on the technical spirit of the appended claims, with functional equivalents thereof to be included therein.

What is claimed is:

1. A method of database management, the method comprising:
identifying an attribute of a metadata table causing increased input/output overhead associated with accessing the metadata table; and
dividing the metadata table into one or more submetadata tables to reduce or eliminate the attribute, or to isolate the attribute to one of the submetadata tables.

2. The method of claim 1, wherein identifying the attribute causing increased input/output overhead comprises identifying a hot key in the metadata table, and
wherein the one of the submetadata tables contains the hot key.

3. The method of claim 2, further comprising:
receiving a key update corresponding to the hot key; and
performing a read-modify-write operation on the one of the submetadata tables.

4. The method of claim 1, wherein identifying the attribute causing increased input/output overhead comprises identifying a key prefix corresponding to a key-value pair of the metadata table that is assigned based on an attribute of the key-value pair, and
wherein the one of the submetadata tables contains keys corresponding to the key prefix.

5. The method of claim 4, further comprising:
receiving a key update corresponding to a hot key associated with the key prefix; and
performing a read-modify-write operation on the one of the submetadata tables.

6. The method of claim 1, wherein identifying the attribute causing increased input/output overhead comprises:
monitoring a ratio of write latency to metadata table size for one or more metadata tables including the metadata table, respectively; and
detecting the ratio for the metadata table as being beyond a threshold ratio.

7. The method of claim 6, wherein an overall write latency associated with the one or more submetadata tables is less than an overall write latency associated the metadata table.

8. A key value store for storing data to a storage device, the key value store being configured to:
identify an attribute of a metadata table causing increased input/output overhead associated with accessing the metadata table; and
divide the metadata table into one or more submetadata tables to reduce or eliminate the attribute, or to isolate the attribute to one of the submetadata tables.

9. The key value store of claim 8, wherein the key value store is configured to identify the attribute causing increased input/output overhead by identifying a hot key in the metadata table, wherein the one of the submetadata tables contains the hot key.

10. The key value store of claim 9, wherein the key value store is further configured to:
receive a key update corresponding to the hot key; and
perform a read-modify-write operation on the one of the submetadata tables.

11. The key value store of claim 8, wherein the key value store is configured to identify the attribute causing increased input/output overhead by identifying a key prefix corresponding to a key-value pair of the metadata table that is assigned based on an attribute of the key-value pair, wherein the one of the submetadata tables contains keys corresponding to the key prefix.

12. The key value store of claim 11, wherein the key value store is further configured to:
receive a key update corresponding to a hot key associated with the key prefix; and
perform a read-modify-write operation on the one of the submetadata tables.

13. The key value store of claim 8, wherein the key value store is configured to identify the attribute causing increased input/output overhead by:
monitoring a ratio of write latency to metadata table size for one or more metadata tables including the metadata table, respectively; and
detecting the ratio for the metadata table as being beyond a threshold ratio.

14. The key value store of claim 13, wherein an overall write latency associated with the one or more submetadata tables is less than an overall write latency associated the metadata table.

15. A non-transitory computer readable medium implemented with a key value store for storing data to a storage device, the non-transitory computer readable medium having computer code that, when executed on a processor, implements a method of database management, the method comprising:
identifying an attribute of a metadata table causing increased input/output overhead associated with accessing the metadata table; and
dividing the metadata table into one or more submetadata tables to reduce or eliminate the attribute, or to isolate the attribute to one of the submetadata tables.

16. The non-transitory computer readable medium of claim 15, wherein identifying the attribute causing increased input/output overhead comprises identifying a hot key in the metadata table, and
wherein the one of the submetadata tables contains the hot key.

17. The non-transitory computer readable medium of claim 16, wherein the computer code, when executed on a processor, further implements the method of database management by:
receiving a key update corresponding to the hot key; and
performing a read-modify-write operation on the one of the submetadata tables.

18. The non-transitory computer readable medium of claim 15, wherein identifying the attribute causing increased input/output overhead comprises identifying a key prefix corresponding to a key-value pair of the metadata table that is assigned based on an attribute of the key-value pair, and
wherein the one of the submetadata tables contains keys corresponding to the key prefix.

19. The non-transitory computer readable medium of claim 18, wherein the computer code, when executed on a processor, further implements the method of database management by:
receiving a key update corresponding to a hot key associated with the key prefix; and
performing a read-modify-write operation on the one of the submetadata tables.

20. The non-transitory computer readable medium of claim 15, wherein identifying the attribute causing increased input/output overhead comprises:
monitoring a ratio of write latency to metadata table size for one or more metadata tables including the metadata table, respectively; and
detecting the ratio for the metadata table as being beyond a threshold ratio.
